(19) United States
(12) Patent Application Publication
(10) Pub. No.: US 2026/0293907 A1
(43) Pub. Date: Oct. 1, 2026

(54) SEED DISINFECTANT AGENT AND METHOD

(71) Applicant: NUNHEMS B.V., Nunhem (NL)

(72) Inventor: Sigrid Werner, Kleinrinderfeld (DE)

(21) Appl. No.: 19/480,435

(22) PCT Filed: May 2, 2024
(86) PCT No.: PCT/EP2024/062044

§ 371 Date: Oct. 31, 2025

(30) Foreign Application Priority Data
May 3, 2023 (EP) 23171306.6

(51) Int. Cl. A01N 59/26; A01N 37/02; A01N 37/16; A01N 59/00; A01P 1/00

(52) U.S. Cl. CPC A01N 59/26; A01N 37/02; A01N 37/16; A01N 59/00; A01P 1/00

(57) ABSTRACT

The present invention refers to a disinfectant composition for controlling and inactivating phytopathogenic pathogens for use on seeds and/or plants and in the area around seeds and/or plants, and methods of using said composition.

### FILED OF THE INVENTION

The present invention is in the field of washing of seeds.

### BACKGROUND OF THE INVENTION

Farmers and plant breeders sustain great damage due to organisms that infect plants and seeds, destroying them or rendering them useless. If, for example, viruses enter a cultivation, it can be assumed that 100% of the plants will be damaged. Specifically active agents are commercially available with which a few phytopathogens can be combated without influencing the vitality of the plant. These agents, designated as pesticides, are sys-temically effective but usually have only a narrow spectrum of activity. On the other hand, a significantly broader spectrum of activity is offered by common disinfecting agents based on aldehydes, phenols, halogens, perox-ides and quaternary ammonium compounds. If these “surface disinfecting agents” get on the plant or are directly applied to the plant, this always entails irreversible damage to the plant and to the environment. This means that such disinfecting agents can only be used on working surfaces, positioning surfaces and devices such as, e.g., knives and the like. The surfaces must be cleaned thereafter from adhering remnants of active substances in order not to endanger the plants during subsequent working steps.

However, a sufficient inactivation is not even assured on surfaces since these agents always exhibit significant gaps in their activity against phytopathogenic organisms.

Typically, vegetable seeds are disinfected and washed with sodium hypochlorite or (tri)sodium phosphate which is not admitted for ecologically produced seeds, such as lettuce, corn salad, tomato, carrot, melon seeds. Alternatively, such seeds were washed with warm water only with the effect though that not all pathogens could be efficiently removed.

It was surprisingly found that the use of certain detergent and washing combinations which are typically used for washing of textiles overcomes the previous deficiency in the combating of phytopathogenic organisms, and that, when applied directly onto the seeds within a specific washing procedure, they retain a pronounced bactericidal, fungicidal and viricidal activity and do not damage the plant cells (roots, stems, leaves, flowers and fruit) in the applied concentration.

### SUMMARY OF THE INVENTION

The present invention relates to disinfecting agents for treating seeds and their environment with the goal of kill-ing off phytopathogenic bacteria, fungi, viruses and viroids and of hindering their spread. Even pathogens (e.g., viruses) that are already on plants can be killed off or inactivated by these agents by moistening roots, stems, leaves and flowers without damaging the plant cells. The biological behavior of the plant is also not altered by the treatment. Working areas in the vicinity of the plants (e.g., tables, knives, positioning surfaces) that could cause a contamination are also freed in a long-lasting manner of noxious organisms therewith without phyto-toxic residues having to be subsequently removed.

### DETAILED DESCRIPTION OF THE PREFERRED EMBODIMENTS OF THE INVENTION

In a first aspect, the invention refers to a disinfectant composition for controlling and inactivating phytopathogenic pathogens for use on seeds and/or plants and in the area around seeds and/or plants, comprising a compound A), B), and, optionally, C), wherein compound A) comprises a basic solution, compound B) comprises an acid solution, and compound C) comprises a dirt removing agent.

The amount of Compound C depends on the degree of dirt on the seeds, i.e. can be omitted if the seeds are less dirty such as tomato, pepper, cucumber or melon seeds as said seeds are retrieved directly from the fruits instead of, e.g. soil.

In a preferred embodiment, compound A) of the disinfectant composition of the present invention comprises sodium hydroxide and/or potassium hydroxide.

Preferably, compound A) comprises up to 25% sodium hydroxide, up to 15% potassium hydroxide, and up to 5% citric acid monohydrate.

In another preferred embodiment, compound B) of the disinfectant composition of the present invention comprises peracetic acid, acetic acid, and/or hydrogen peroxide.

Preferably, compound B) comprises 25-50% hydrogen peroxide, 2.5-10% peracetic acid, and 2.5-10% acetic acid.

In another preferred embodiment, compound C) of the disinfectant composition of the present invention comprises phosphate.

In another preferred embodiment, compound C) comprises a non-ionic surfactant such as a polyalkylene gly-colether, that is based on a saturated iso-C13-alcohol with 8 moles ethylene oxide.

In another aspect, the invention refers to a method for disinfecting seeds using the composition of the present invention, said method comprising the steps of
a. Pre-Washing the seeds in a washing machine, optionally in the presence of compound C),
b. Washing the seeds in the washing machine in the presence of compound A) and B), wherein compound A) and compound B) are added subsequently, and
c. Rinsing the seeds in the washing machine.

As stated above, the amount of compound C) in step a. depends on the dirtiness of the seeds and can vary—if added—between 2 to 10 g per kg seeds.

The inventor of the present invention has found out that the disinfection of the seeds is more effective if the pre-washing step a. is repeated. Thus, in a preferred embodiment, step a. is repeated two, three, preferably four times.

The first two pre-wash rounds are preferably short and may last around 5 minutes. The third pre-wash round may last up to 8 minutes. The fourth pre-wash round can be essential to remove any remaining dirt traces and may thus last up to 12 minutes at 40 degree Celsius.

Moreover, the temperature of the prewashing step a. which is essential to remove the dirt can be varied, i.e. can occur using cold water. However, removal of dirt works better if the washing temperature is raised up to 40 degrees Celsius. It has to be noted, that the temperature of the last pre-wash shouldn't exceed 45 degrees Celsius, otherwise germination capacity of the seeds would be negatively impacted. As a general rule, the duration time of the pre-washing round should be shortened if the washing temperature is increased.

The inventor of the present invention has found out that adding compound B) to compound A) during the washing step b. leads to a redox reaction which is essential for the seed disinfection. However, the amount of added B) should exceed the amount of A) three times.

Thus, in another preferred embodiment, the ratio of compound A) to B) is 1:3. In a particularly preferred embodiment, the pH value is between 7 and 9.

In general, the amount of compound A) can vary between 5 and 50 g per kg seeds. Accordingly, the amount of compound B) can vary between 15 and 150 g per kg seeds.

Preferably, compound B) is added after compound A), more preferably at a time point when the washing temperature has reached 50 degrees Celsius.

Thus, in another preferred embodiment, the washing temperature of washing step b. is between 30 and 55 degrees Celsius, preferably 48 to 53 degrees Celsius, most preferably 50 degrees Celsius.

The rinsing in step c. is preferably repeated two times and can occur for 3 minutes with unheated water. It serves to immediately cool down the seeds to avoid premature germination and to wash out any remaining chemical agents.

Any customary washing machine is useful to carry out the method of the present invention.

The invention is further described in the following non-limiting examples.

### EXAMPLE 1: MATERIAL

30 kg Corn salad seeds, and a commercially used washing machine with 140 Liter volume (e.g. Electrolux).

### EXAMPLE 2: WASHING PROCESS ACCORDING TO THE PRIOR ART

Seeds are pre-washed in the washing machine without any chemical agent. Subsequently, seeds are washed (step b.) with sodium hypochlorite on cold water (with 1-4% active chloride). Washing is followed by three rinsing rounds to remove chloride. Alternatively, seeds are washed between 10 and 60 minutes in warm water, i.e. at a temperature between 45 and 60 degrees Celsius.

### EXAMPLE 3: PRE-WASHING PROCESS ACCORDING TO PRESENT INVENTION

Seeds are pre-washed four times to remove dirt using compound C) containing less than 2% potassium hydroxide and at least 30% phosphate. The dose is 6 g compound C per kg seeds in a 140 L volume washing machine. 30 kg seeds per wash round can be washed. To remove most of the dirt, the first and second pre-wash is performed at 30 degrees Celsius for 5 min. The third pre-wash is performed at 40 degrees Celsius for 8 min. The fourth pre-wash is performed at 40 degrees Celsius for 12 min. This last step dissolves remaining traces of dirt, whereby some pathogens are initially killed by the increasing heat as well. Furthermore, due to the swelling process the seeds get more susceptible for the subsequent disinfection.

### EXAMPLE 4: MAIN WASHING PROCESS ACCORDING TO THE PRESENT INVENTION

The seeds need to be main washed only one time. The washing drum is filled with 140 Liter water, pre-warmed to 50 degrees Celsius. Compound A) is added at a dose of 21 g per kg seeds directly at the start of the washing round where it directly reacts with the hydrophobic moieties of the pathogens due to its basic pH value. When the water level is reached and 50 degrees Celsius are stably maintained, compound B) is added at a dose of 60 g per kg seeds. The addition of the acidic to the basic solution leads to a redox reaction which is essential for the disinfection of the seeds.

### EXAMPLE 5: RINSING

Seeds are rinsed with 2 rinsing rounds, each for three minutes, using water at room temperature.

1. Disinfectant composition for controlling and inactivating phytopathogenic pathogens for use on seeds and/or plants and in the area around seeds and/or plants, comprising a compound A), B), and, optionally, C), wherein compound A) comprises a basic solution, compound B) comprises an acid solution, and compound C) comprises a dirt removing agent.

2. Disinfectant composition according to claim 1, wherein compound A) comprises sodium hydroxide and/or potassium hydroxide.

3. Disinfectant composition according to claim 1, wherein compound B) comprises peracetic acid, acetic acid, and/or hydrogen peroxide.

4. Disinfectant composition according to claim 1, wherein compound C) comprises phosphate.

5. Method for disinfecting seeds using the composition as defined in claim 1, said method comprising the steps of
a. Pre-Washing the seeds in a washing machine, optionally in the presence of compound C),
b. Washing the seeds in the washing machine in the presence of compound A) and B), wherein compound A) and compound B) are added subsequently, and
c. Rinsing the seeds in the washing machine.

6. Method according to claim 5, wherein step a. is repeated two times.

7. Method according to claim 5 or 6, wherein the ratio of compound A) to B) is 1:3.

8. Method according to claim 5, wherein the washing temperature of washing step b. is between 30 and 55 degrees Celsius.

9. Method according to claim 8, wherein the washing temperature of washing step b. is between 48 to 53 degrees Celsius.

10. Method according to claim 9, wherein the washing temperature of washing step b. is 50 degrees Celsius.

11. Disinfectant composition according to claim 2, wherein compound B) comprises peracetic acid, acetic acid, and/or hydrogen peroxide.

12. Disinfectant composition according to claim 2, wherein compound C) comprises phosphate.

13. Disinfectant composition according to claim 3, wherein compound C) comprises phosphate.

14. Disinfectant composition according to claim 11, wherein compound C) comprises phosphate.

15. Method according to claim 5, wherein step a. is repeated three times.

16. Method according to claim 5, wherein step a. is repeated four times.
